(19) United States
(12) Patent Application Publication
(10) Pub. No.: US 2011/0242695 A1
(43) Pub. Date: Oct. 6, 2011

(54) DISK DEVICE AND RELATED WRITE METHOD

(75) Inventor: Ju-young LEE, Seoul (KR)

(73) Assignee: SAMSUNG ELECTRONICS CO., LTD., Suwon-si (KR)

(21) Appl. No.: 13/079,943

(22) Filed: Apr. 5, 2011

(30) Foreign Application Priority Data
Apr. 6, 2010 (KR) 10-2010-0031558

(51) Int. Cl. G11B 5/02

(52) U.S. Cl. 360/55; G9B/5.026

(57) ABSTRACT

A method of performing a write operation in a disk device comprises storing multiple units of data in a first area of a buffer, wherein each of the units of data has a size that is different from a size of a corresponding target sector of a disk. The method further comprises transferring data from a first target sector to second and third areas of the buffer, and writing the data stored in the first area of the buffer and the data stored in the third area of the buffer to the first target sector.

### CROSS-REFERENCE TO RELATED APPLICATIONS

This application claims priority under 35 U.S.C. §119 to Korean Patent Application No. 10-2010-0031558 filed on Apr. 6, 2010, the disclosure of which is hereby incorporated by reference in its entirety.

### BACKGROUND OF THE INVENTION

Embodiments of the inventive concept relate generally to electronic data storage technologies. More particularly, embodiments of the inventive concept relate to disk devices and methods of writing data in the disk devices.

A hard disk drive stores data on a magnetic disk divided into a plurality of sectors. The hard disk drive receives data from a host and writes the data to a target sector using a write head. The process of writing the data to the target sector can increase in complexity if the data has a different size from the target sector.

### SUMMARY OF THE INVENTION

According to one embodiment of the inventive concept, a method is provided for performing a write operation in a disk device comprising a disk having a plurality of sectors. The method comprises storing multiple units of data in a first area of a buffer, wherein each of the units of data has a size that is different from a size of a corresponding target sector of the disk. The method further comprises transferring data to second and third areas of the buffer from a first target sector of the disk, wherein the first target sector corresponds to a first unit of data among the units of data, and writing the first unit of data from the first area of the buffer to the first target sector and writing the data transferred to the third area of the buffer to the first target sector. Transferring the data to the second and third areas of the buffer comprises storing in the second area of the buffer a part of the data to be replaced by the first unit of data, and storing in the third area of the buffer a remaining part of the data.

In certain embodiments, the method further comprises identifying a second target sector as a sector that is closest to the first target sector among target sectors to which the multiple units of data are to be written, and storing data from the second target sector in the second and third areas of the buffer, or writing one of the units of data from the first area of the buffer to the second target sector.

In certain embodiments, storing data from the second target sector in the second and third areas of the buffer is performed upon determining that the data from the second target sector is not currently stored in the second and third area of the buffer, and wherein writing one of the units of data from the first area of the buffer to the second target sector is performed upon determining that the data from the second target sector is currently stored in the second and third area of the buffer.

In certain embodiments, identifying the second target sector comprises accessing a table that stores seek times of a disk drive head, and identifying the second target sector as a sector having a lowest seek time relative to the first target sector.

In certain embodiments, the table is selected from among a first table storing seek times for write operations, and a second table storing seek times for read operations.

In certain embodiments, the method further comprises selecting the first table upon determining that a write operation is to be performed on the second target sector, and selecting the second table upon determining that a read operation is to be performed on the second target sector.

In certain embodiments, identifying the second target sector comprises determining whether a first track containing the first target sector contains any additional target sectors where one of the multiple units of data is to be written, and upon determining that the first track contains at least one additional target sector to which one of the multiple units of data is to be written, identifying one of the at least one additional target sectors as the second target sector.

In certain embodiments, the disk device is a hard disk drive.

According to another embodiment of the inventive concept, a method is provided for performing a write operation in a disk device. The method comprises storing data received from a host in a first area of a buffer, reading data from a sector to which the received data is to be written, storing a part of the read data corresponding to the received data in a second area of the buffer, storing a remaining part of the read data other than the part of the read data corresponding to the received data in a third area of the buffer, and writing the data stored in the first area and the third area of the buffer to the sector.

In certain embodiments, the method further comprises receiving the data from the host, comparing a size of the received data with a size of the sector to which the received data is to be written, and reading the data from the sector to which the received data is to be written as a consequence of determining that the size of the received data is different from the size of the sector to which the received data is to be written.

In certain embodiments, the method further comprises reading additional data from the host, storing the additional data in the first area of the buffer, comparing a size of the additional data with a size of a second sector to which the additional data is to be written, and writing the additional data from the first area of the buffer to the second sector.

In certain embodiments, the sector has a size of 4 kilobytes.

According to still another embodiment of the inventive concept, a disk device comprises a disk comprising a plurality of tracks each comprising a plurality of sectors, a head that writes data to the disk and reads data from the disk, a buffer comprising a first area, a second area, and a third area, and a controller that controls the disk device to store data received from a host in the first area, to store data in the second area and the third area from a first target sector to which the received data is to be written, and to write the data stored in the first area and the third area to the first target sector. The controller controls the disk device to store a part of the read data corresponding to the received data in the second area, and to store a remaining part of the read data other than the part of the read data corresponding to the received data to the third area.

In certain embodiments, the controller compares a size of the received data with a size of the first target sector. Upon determining that the size of the received data is the same as the size of the first target sector, the controller controls the disk device to store the data in the first area into the first target sector, and upon determining that the size of the received data is not the same as the size of the first target sector, the controller controls the disk device to transfer data from the first target sector to the second and the third areas, and to write data stored in the first area and the third area into the first target sector.

In certain embodiments, the controller controls the disk device to store multiple units of data received from the host into the first area, wherein each of the units of data has a size that is different from a size of a corresponding target sector to which the unit of data is to be written.

In certain embodiments, the controller searches for a second target sector that is closest to the first target sector among target sectors where the multiple units of data are to be written.

In certain embodiments, the controller controls the disk device to transfer data from the second target sector to the second and third areas or to write data from the first area and the third area to the second target sector.

In certain embodiments, the controller determines whether data stored in the second target sector has been stored in the second and third areas. Upon determining that the data stored in the second target sector has been stored in the second and third areas, the controller controls the disk device to write data stored in the first and third areas into the second target sector. Upon determining that the data stored in the second target sector has not been stored in the second and third areas, the controller controls the disk device to transfer data stored in the second target sector into the second and third areas.

In certain embodiments, the disk device further comprises a memory for storing a first table comprising information regarding seek times of the head for write operations and a second table comprising information regarding seek times of the head for read operations. The controller searches for the second target sector by examining the seek times in the first or second table.

In certain embodiments, the controller identifies the second target sector by determining whether a first track containing the first target sector contains any additional target sectors in which one of the multiple units of data is to be written, and upon determining that the first track contains at least one additional target sector to which one of the multiple units of data is to be written, identifies one of the at least one additional target sectors as the second target sector.

### BRIEF DESCRIPTION OF THE DRAWINGS

The drawings illustrate selected embodiments of the inventive concept. In the drawings, like reference numbers indicate like features.

FIG. 1 is a plan view of a hard disk drive according to an embodiment of the inventive concept.

FIG. 2 is a block diagram illustrating electrical circuitry of the hard disk drive of FIG. 1.

FIG. 3 is a block diagram of a hard disk drive according to an embodiment of the inventive concept.

FIG. 4 is a flowchart illustrating a method of performing a write operation in the hard disk drive of FIG. 3 according to an embodiment of the inventive concept.

FIG. 5A illustrates a buffer of the hard disk drive of FIG. 3 according to an embodiment of the inventive concept.

FIG. 5B illustrates a sector of a disk in the hard disk drive of FIG. 3 according to an embodiment of the inventive concept.

FIG. 6 is a flowchart illustrating a method or performing a write operation in the hard disk drive of FIG. 3 according to an embodiment of the inventive concept.

FIG. 7A illustrates a buffer of the hard disk drive of FIG. 3 according to an embodiment of the inventive concept.

FIG. 7B illustrates a track of a disk in the hard disk drive of FIG. 3 according to an embodiment of the inventive concept.

FIG. 8 illustrates a disk of the hard disk drive of FIG. 3 according to an embodiment of the inventive concept.

FIG. 9 illustrates a disk of the hard disk drive of FIG. 3 according to an embodiment of the inventive concept.

FIG. 10 illustrates a disk of the hard disk drive of FIG. 3 according to an embodiment of the inventive concept.

FIG. 11A is a table illustrating seek times of a magnetic head in a write operation of a hard disk drive.

FIG. 11B is a table illustrating seek times of a magnetic head in a read operation of a hard disk drive.

### DETAILED DESCRIPTION

Embodiments of the inventive concept are described below with reference to the accompanying drawings. These embodiments are presented as teaching examples and should not be construed to limit the scope of the inventive concept.

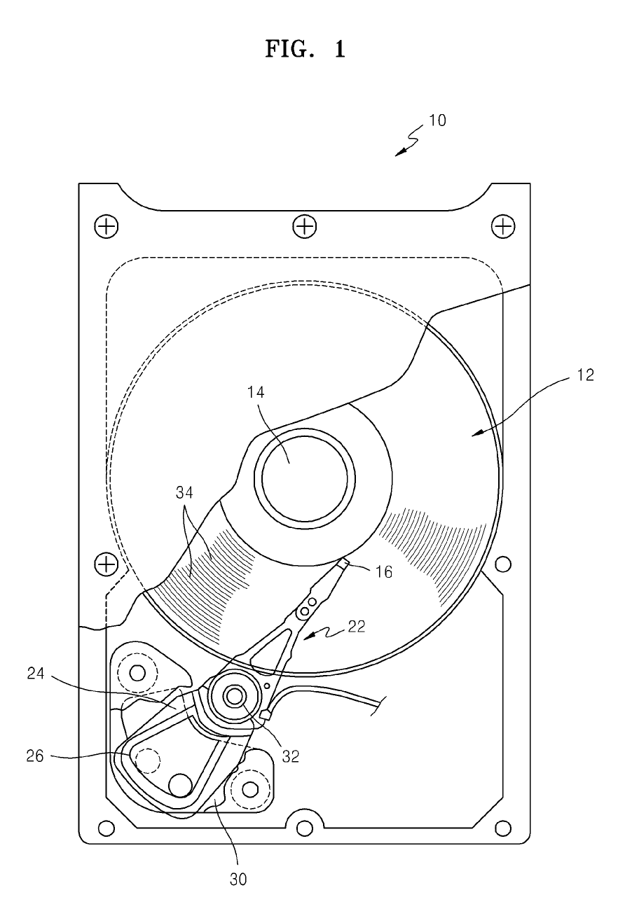

FIG. 1 is a plan view of a hard disk drive 10 according to an embodiment of the inventive concept.

Referring to FIG. 1, hard disk drive 10 comprises at least one disk 12 rotated by a spindle motor 14. Hard disk drive 10 further comprises a transducer disposed close to a surface of disk 12.

The transducer reads information on disk 12 by detecting a magnetic field of disk 12 and writes information on disk 12 by magnetizing disk 12. Although the transducer is described as a single transducer, the transducer can comprise a write transducer for magnetizing disk 12 and a read transducer for detecting a magnetic field of disk 12. The read transducer is typically formed of a magneto-resistive device.

The transducer is integrated into a magnetic head 16. Magnetic head 16 generates an air bearing between the transducer and the surface of disk 12. Magnetic head 16 is coupled to a head stack assembly (HSA) 22. HSA 22 is attached to an actuator arm 24 comprising a voice coil 26. Voice coil 26 is disposed close to a magnetic assembly to define a voice coil motor (VCM) 30. Where current is supplied to voice coil 26, torque is generated to rotate actuator arm 24 around a bearing assembly 32. The rotation of actuator arm 24 moves the transducer across the surface of disk 12.

Information is stored in circular tracks 34 of disk 12. Each of tracks 34 comprises a plurality of sectors. Each of the sectors comprises a data field and a servo field. The servo field stores a preamble, a servo address/index mark (SAM/SIM), a gray code, and burst signals. The transducer moves across the surface of disk 12 to read or write information in different tracks.

Magnetic head 16 comprises a structure for generating the air bearing between the surface of disk 12 and the read and write transducers, and further comprises a heater for heating the structure for generating the air bearing.

Where multiple disks 12 are mounted on hard disk drive 10, multiple magnetic heads 16 are mounted on surfaces of disks 12. For example, where two disks are mounted on hard disk drive 10, four magnetic heads 16 are mounted on HSA 22. Magnetic heads 16 can be simply referred to as heads.

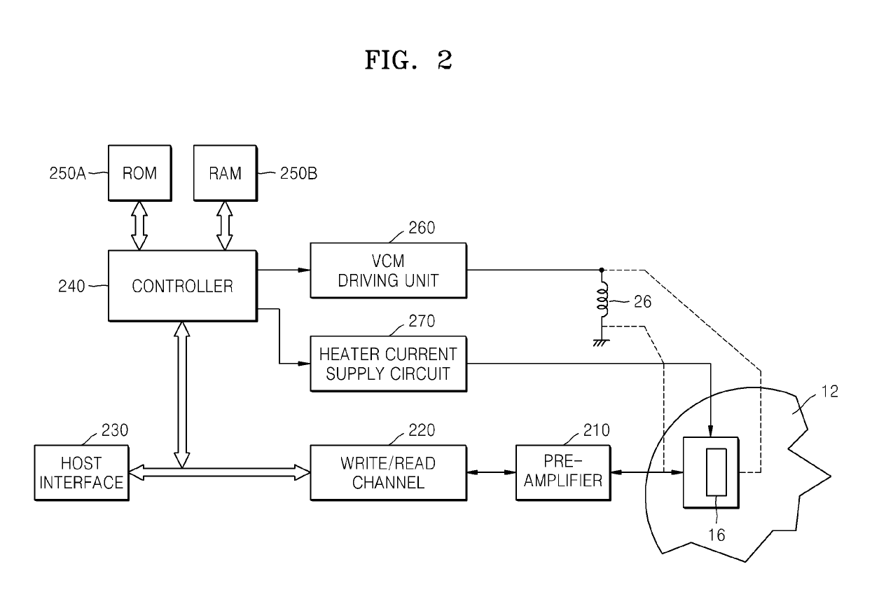

FIG. 2 is a block diagram illustrating electrical circuitry of hard disk drive 10 of FIG. 1.

Referring to FIGS. 1 and 2, hard disk drive 10 comprises disk 12, magnetic head 16, voice coil 26, a pre-amplifier 210, a write/read channel 220, a host interface 230, a controller 240, a read-only memory (ROM) 250A, a random-access memory (RAM) 250B, a VCM driving unit 260, and a heater current supply circuit 270.

ROM 250A stores firmware and operating information for controlling the disk drive. RAM 250B stores operating information read from ROM 250A or disk 12 while hard disk drive 10 is powered on.

Controller 240 analyzes commands received from a host through host interface 230 and performs control operations according to the analyzed commands. Controller 240 supplies control signals to VCM driving unit 260 to control the movement of magnetic head 16.

In a data read mode, hard disk drive 10 operates pre-amplifier 210 to amplify an electrical signal detected from disk 12 by the read transducer of magnetic head 16. Write/read channel 220 amplifies the signal amplified by pre-amplifier 210 to a predetermined level by controlling a gain using an automatic gain control circuit, converts the signal amplified by the automatic gain control circuit into a digital signal, converts the digital signal into stream data, and transmits the stream data to the host through host interface 230.

In a data write mode, hard disk drive 10 receives data from the host through host interface 230, converts the data received from the host into a binary data stream using write/read channel 220, and writes the binary data stream onto disk 12 through the write transducer of magnetic head 16 using a write current amplified by pre-amplifier 210.

Write/read channel 220 provides information for track-seeking and track-following control to controller 240 by reproducing the preamble, the SAM/SIM, the gray code, and burst signals recorded in the servo field of disk 12. However, in a servo copy process, write/read channel 220 provides information necessary for track seeking and tracking control to controller 240 by reproducing a reference servo pattern recorded on a surface of one of a plurality of disks using a reference head.

Although FIGS. 1 and 2 illustrate a hard disk drive, the inventive concept is not limited to hard disk drives and can be embodied in other types of disk devices.

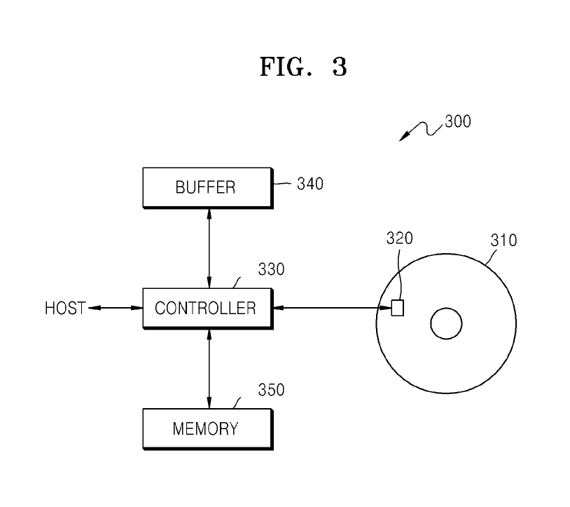

FIG. 3 is a diagram illustrating a hard disk drive 300 according to an embodiment of the inventive concept.

Referring to FIG. 3, hard disk drive 300 comprises a disk 310, a head 320, a controller 330, a buffer 340, and a memory 350. Disk 310 comprises a plurality of tracks each comprising a plurality of sectors. Head 320 writes data to sectors of disk 310 and reads data from sectors of disk 310.

Buffer 340 stores data received from a host HOST or data read from disk 310. Buffer 340 is divided into a first area, a second area, and a third area. The first through third areas of buffer 340 are used in write operations of hard disk drive 300.

Controller 330 stores data received from host HOST in the first area of buffer 340. Where the size of the received data is different from the size of a target sector to which the received data is to be written, controller 330 reads data stored in the target sector and stores the read data in the second area and the third area of buffer 340. In other words, controller 330 stores part of the read data in the second area, and a remaining part of the read data in the third area. Where the size of the received data is the same as the size of the target sector, controller 330 controls head 320 to write the data stored in the first area to the target sector.

Where multiple units of data are received from host HOST, controller 330 stores each of the received units in the first area of buffer 340. Controller 330 searches for a closest sector where data stored in the first area is to be written. The closest sector can be, for instance, a sector from which data stored in the second area and the third area has been read or to which data stored in the first area and the third area is to be written. Upon identifying the closest sector, controller 330 controls hard disk drive 300 to read data stored in the closest sector and to store the read data in the second area and the third area, or controls hard disk drive 300 to write the data stored in the first area and the third area to the closest sector.

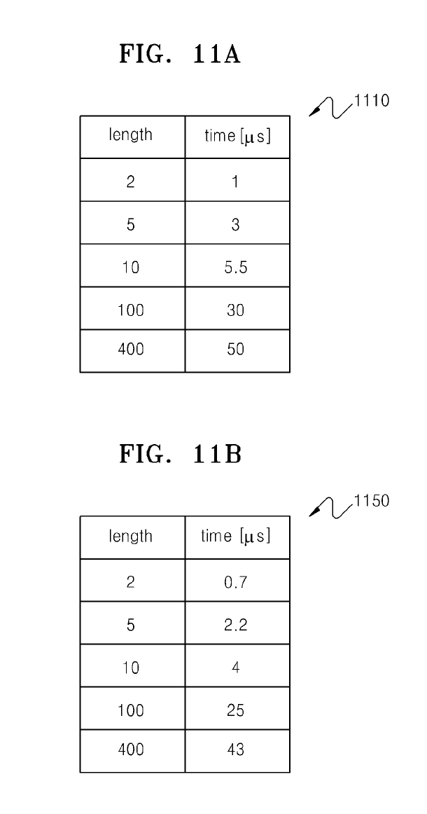

Controller 330 searches for the closest sector by using a first table and a second table. The first table comprises information about a seek time of head 320 for write operations. The second table comprises information about a seek time of head 320 for read operations. The first table and the second table can be stored in memory 350. Examples of the first table and the second table are shown in FIGS. 11A and 11B.

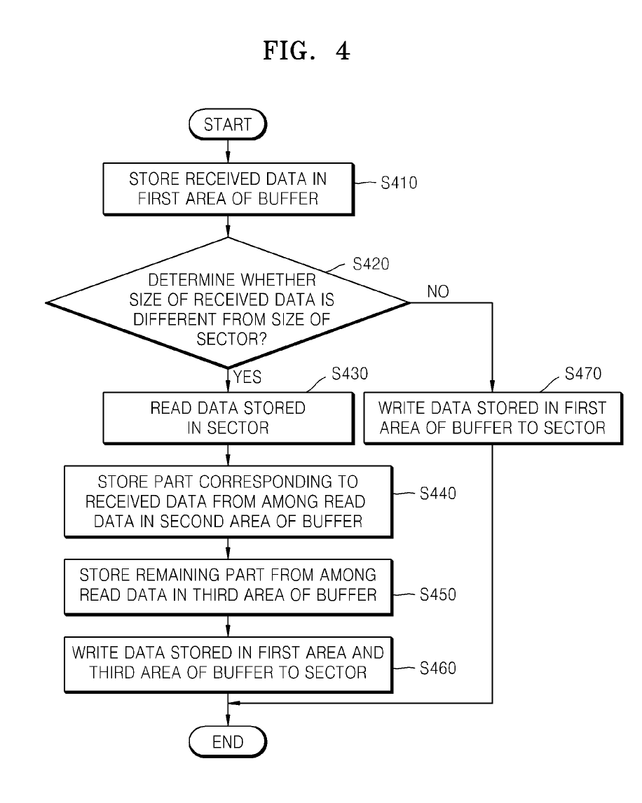

FIG. 4 is a flowchart illustrating a method of performing a write operation in hard disk drive 300 of FIG. 3 according to an embodiment of the inventive concept. In the description that follows, example method steps will be indicated by parentheses (SXXX).

Referring to FIGS. 3 and 4, controller 330 stores data received from host HOST in the first area of buffer 340 (S410). Next, controller 330 compares a size of the received data with a size of a target sector to which the received data is to be written (S420). Where the size of the received data is different from the size of the target sector (S420=YES), controller 330 controls head 320 to read data stored in the target sector (S430). Then, controller 330 stores part of the read data to be replaced by the received data in the second area of buffer 340 (S440), and stores a remaining part of the read data in the third area of buffer 340 (S450). Thereafter, controller 330 controls head 320 to write the data stored in the first area and the third area of buffer 340 in the target sector (S460).

Otherwise, where the size of the received data is the same as the size of the target sector (S420=NO), controller 330 controls head 320 to write the data stored in the first area of buffer 340 to the target sector (S470).

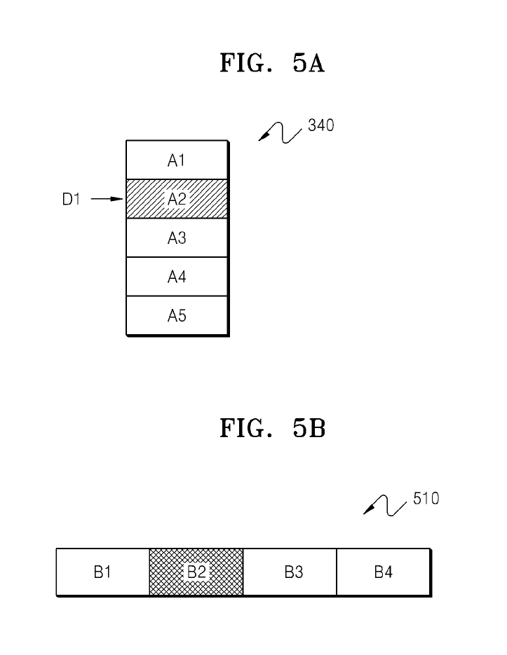

FIG. 5A illustrates an embodiment of buffer 340 of hard disk drive 300, and FIG. 5B illustrates a sector 510 of disk 310 of hard disk drive 300. In the example of FIGS. 5A and 5B, data D1 is received from host HOST and data D1 is to be written to sector 510. Data D1 is to replace data B2 among data B1 through B4 stored in sector 510. Data D1 can comprise, for instance, 512 bytes and sector 510 can comprise, for instance, 4 Kbytes.

Referring to FIGS. 3 through 5B, controller 330 stores data D1 in a first area A2 of buffer 340. Because the size of data D1 is different from the size of sector 510, controller 330 reads data B1 through B4 from sector 510 and stores it in a second area A5 and third areas A1, A3, and A4 of buffer 340. More specifically, controller 330 stores data B2, which is to be replaced by data D1, in second area A5 of buffer 340, and stores remaining data B1, B3, and B4 in third areas A1, A3, and A4 of buffer 340. Controller 330 controls head 320 to write the data stored in first area A2 and third areas A1, A3, and A4 of buffer 340 to sector 510.

Although data D1 has a size that is ⅛ of the size of sector 510, the relative size of data D1 and sector 510 can be varied in alternative embodiments.

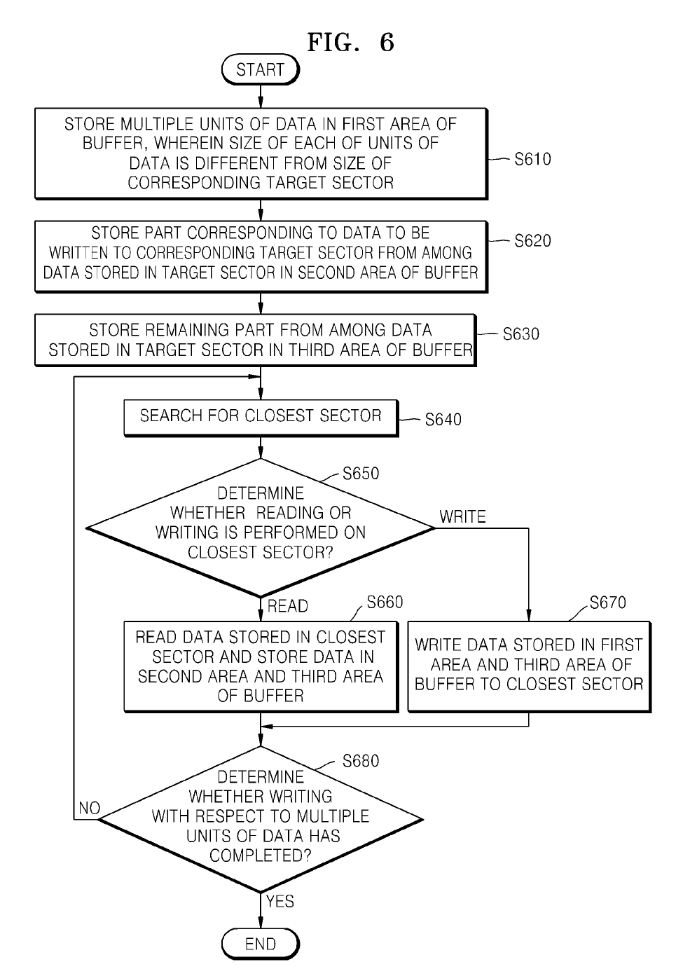

FIG. 6 is a flowchart illustrating a method of performing a write operation in hard disk drive 300 according to another embodiment of the inventive concept. In the method of FIG. 6, multiple units of data are to be written to corresponding target sectors, and some of the multiple units of data have a different size from the corresponding target sectors. Where hard disk drive 300 receives data having the same size as a corresponding target sector, hard disk drive 300 performs a write operation similar to operation S470 of FIG. 4. In the method of FIG. 6, hard disk drive 300 receives first data and second data from host HOST and stores the first data and the second data in respective first and second sectors.

Referring to FIGS. 3 and 6, controller 330 stores multiple units of data in the first buffer area of buffer 340 (S610). More specifically, controller 330 stores the first data and the second data in the first area of buffer 340. The first and second data have different sizes from corresponding first and second sectors of disk 310.

Next, controller 330 controls head 320 to read data stored in the first sector. Controller 330 then stores a first part of the data read from the first sector in the second area of buffer 340 (S620). The first part of the data read from the first sector is a part to be replaced by the first data received from host HOST. Thereafter, controller 330 stores a remaining part of the data read from the first sector in the third area of buffer 340 (S630). Next, controller 330 searches for a sector of disk 310 that is closest to the first sector and where received data is to be written (S640). In the example of FIG. 6, the closest sector is the second sector.

Thereafter, controller 330 determines whether a read operation or a write operation is to be performed on the second sector (S650). Where data stored in the second sector is already stored in the second area and the third area of buffer 340, controller 330 determines that a write operation is to be performed on the second sector. Otherwise, where data stored in the second sector is not yet stored in the second area and the third area of buffer 340, controller 330 determines that a read operation is to be performed on the second sector.

Where a read operation is to be performed on the second sector (S650=READ), controller 330 reads the data stored in the second sector and stores the read data in the second area and the third area of buffer 340 (S660). Controller 330 stores part of the read data corresponding to the second data in the second area of buffer 340 and stores a remaining part of the read data in the third area of buffer 340.

Where a write operation is to be performed on the second sector (S650=WRITE), controller 330 controls hard disk drive 330 to write the second data stored in the first area of buffer 340 in the second sector, and to write the data read from the second sector and stored in the third area of buffer 340 in the second sector (S670).

After operation S660 or S670, controller 330 determines whether the write operation has been completed for each of the multiple units of data (S680). If not (S680=NO), the method returns to operation S640.

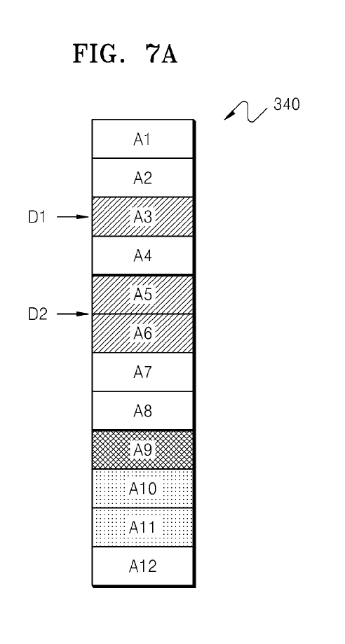

FIG. 7A illustrates another embodiment of buffer 340 of hard disk drive 300, and FIG. 7B illustrates a track 710 of disk 310 of hard disk drive 300. In the example of FIGS. 7A and 7B, first data D1 and second data D2 are received from host HOST, and first data D1 and second data D2 are to be written to track 710. Track 710 comprises a first sector 750 in which data B1 through B4 is stored, a second sector 760 in which data B5 through B8 is stored, and a third sector 770 in which data B9 through B12 is stored.

Referring to FIGS. 3 and 6 through 7B, controller 330 stores first data D1 and second data D2 in first areas A3, A5, and A6 of buffer 340. In particular, controller 330 stores first data D1 in first area A3 of buffer 340 and stores second data D2 in first areas A5 and A6 of buffer 340. First data D1 is data to replace data B3 stored in first sector 750, and second data D2 is to replace data B9 and B10 stored in third sector 770. The sizes of first data D1 and second data D2 are 512 bytes and 1024 bytes, respectively, and sizes of the first and third sectors 750 and 770 are 4 Kbytes.

Because the size of first data D1 is different from the size of first sector 750, controller 330 reads data B1 through B4 from first sector 750 and stores it in a second area A9 and third areas A1, A2, and A4 of buffer 340. More specifically, controller 330 stores data B3, which corresponds to data D1, in second area A9 of buffer 340, and stores remaining data B1, B2, and B4 in third areas A1, A2, and A4 of buffer 340.

Next, controller 330 identifies third sector 770 as a closest sector, relative to first sector 750, in which received data is to be stored. Data B9 through B12 of third sector 770 are initially not stored in buffer 340, so controller 330 reads data B9 through B12 stored in third sector 770 and stores read data B9 through B12 in second areas A10 and A11 and third areas A7 and A8 of buffer 340. More specifically, controller 330 stores data B9 and B10, which corresponds to received data D2, in second areas A10 and A11, and stores remaining data B11 and B12 in third areas A7 and A8 of buffer 340.

Next, controller 330 searches for first sector 750, which is the closest sector, relative to third sector 770, in which received data is to be written. Controller 330 then controls hard disk drive 300 to write the data stored in first area A3 and third areas A1, A2, and A4 of buffer 340 in first sector 750.

Next, controller 330 searches for third sector 770, which is the closest sector, relative to first sector 750, in which received data is to be stored. Controller 330 then controls hard disk drive 300 to write the data stored in first areas A5 and A6 and third areas A7 and A8 of buffer 340 in second sector 770.

Although first data D1 and second data D2 have sizes that are ⅛ and ¼ the size of first sector 750 and third sector 770, respectively, the sizes of first and second data D1 and D2 can be varied in alternative embodiments.

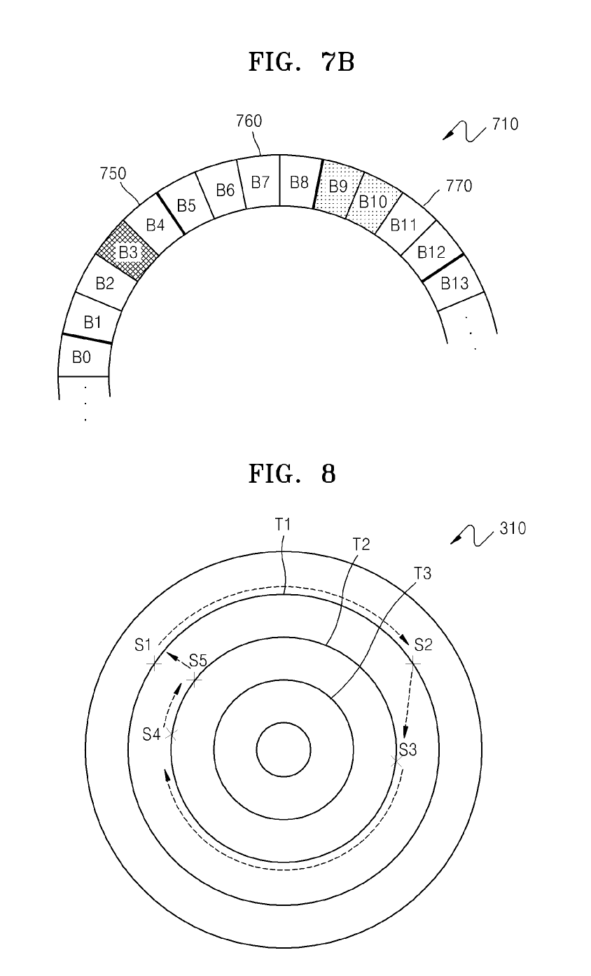

FIG. 8 illustrates an example of disk 310 of hard disk drive 300 of FIG. 3. FIG. 8 is used to describe an example of the method of FIG. 6. In the example of FIG. 8, data is read from each of first through fifth sectors S1 through S5 before received data is written to first through fifth sectors S1 through S5.

Referring to FIGS. 3, 6, and 8, disk 310 comprises first through third tracks T1 through T3 each comprising a plurality of sectors. First track T1 comprises a first sector S1 and a second sector S2. Second track T2 comprises a third sector S3, a fourth sector S4, and a fifth sector S5. First through fifth data is to be written in respective first through fifth sectors S1 through S5. The first through fifth data have different sizes from the respective first through fifth sectors S1 through S5.

Data of first sector S1 is stored in the second area and the third area of buffer 340 by performing operations S620 and S630. Controller 330 then determines whether there is a closest sector to which received data is to be written in the same track as first sector S1. Where it is determined that there is no closest sector in the same track as first sector S1, it is determined whether there is a closest sector to which the received data is to be written in another track.

Next, controller 330 searches for a closest sector in the same track as first sector S1 where received data is to be stored. Because second sector S2 is in first track T1, and second data is to be stored in second sector S2, second sector S2 is identified as the closest sector where received data is to be written. Controller 330 then controls hard disk drive 300 to perform operation S660 to store data from second sector S2 in the second area and the third area of buffer 340.

Next, because there is no other sector for performing operation S660 in first track T1, controller 330 searches for a closest sector for performing operation S660 from among the third through fifth sectors S3, S4, and S5. Third sector S3 is a closest sector, relative to second sector S2, in which received data is to be written. Accordingly, sector S3 is identified in operation S640 as the closest sector. Controller 330 then controls hard disk drive 300 to perform operation S660 to store data of third sector S3 in the second area and the third area of buffer 340.

Next, controller 330 searches for a closest sector in which received data is to be stored from among sectors of second track T2. Fourth sector S4 is a sector closest to third sector S3 in second track T2, so fourth sector S4 is identified as the closest sector. Controller 330 then controls hard disk drive 300 to perform operation S660 to store data of fourth sector S4 in the second area and the third area of buffer 340.

Next, controller 330 searches for a closest sector in which the received data is to be stored from among the sectors of second track T2. Fifth sector S5 is a sector closest to fourth sector S4 in second track T2, so fifth sector S5 is identified as the closest sector. Controller 330 then controls hard disk drive 300 to perform operation S660 to store data of fifth sector S5 in the second area and the third area of buffer 340.

After the data of the first through fifth sectors S1 through S5 has been stored in the second area and the third area of buffer 340, controller 330 searches for a sector located closest to fifth sector S5 and to which data in buffer 340 is to be written. First sector S1 is identified as the closest sector to fifth sector S5 and to which data in buffer 340 is to be stored. Controller 330 then controls hard disk drive 300 to perform operation S670 to write data from buffer 340 to first sector S1. Subsequently, operation S670 is performed in the same order as that used to perform operation S660, that is, in the order of second sector S2, third sector S3, fourth sector S4, and fifth sector S5.

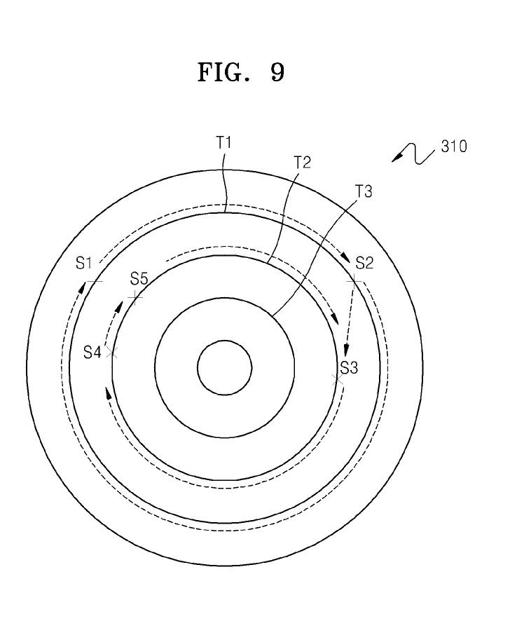

FIG. 9 illustrates another example of disk 310 of FIG. 3. FIG. 9 is used to describe an example of the method of FIG. 6. In the example of FIG. 9, data is written into each sector in the same track before data is read or written in sectors of different tracks.

Referring to FIGS. 3, 6, and 9, disk 310 comprises first through third tracks T1, T2, and T3 each comprising a plurality of sectors. First track T1 comprises a first sector S1 and a second sector S2, and second track T2 comprises a third sector S3, a fourth sector S4, and a fifth sector S5. First through fifth data is to be written in respective first through fifth sectors S1 through S5. The first through fifth data have different sizes from the respective first through fifth sectors S1 through S5.

Data of first sector S1 is stored in the second area and the third area of buffer 340 by performing operations S620 and S630. Controller 330 determines whether first track T1 containing first sector S1 contains a closest sector to which the received data is to be written. Upon determining that track T1 does not contain a closest sector, controller 330 determines whether another track contains a closest sector to which the received data is to be to be written. Controller 330 controls operations for storing data from first through fifth sectors S1 through S5 into buffer 340 and operations for writing data from buffer 340 to corresponding sectors.

After operations S620 and S630, controller 330 determines whether first track T1 contains a sector to which received data is to be written. In the example of FIG. 9, first track T1 contains second sector S2 to which the second data is to be written. Accordingly, second sector S2 is identified as a closest sector. Controller 330 then controls hard disk drive 300 to perform operation S660 to store data of second sector S2 in the second area and the third area of buffer 340.

Next, operation S640 is performed to identify second sector S2 as the sector closest to first sector S1. Then, controller 330 controls hard disk drive 300 to perform operation S670 to store data from the first and third areas of buffer 340 into second sector S2.

Next, operation S640 identifies third sector S3 as a closest sector where received data is to be written because there are no remaining sectors in first track T1 where received data is to be written. Controller 330 controls hard disk drive 300 to perform operation S660 to store data from third sector S3 in the second and third areas of buffer 340.

Next, controller 330 searches for a closest sector, relative to third sector S3, in which the received data is to be stored in second track T2. Fourth sector S4 is identified as the closest sector. Controller 330 then performs operation S660 to store data of fourth sector S4 in the second area and the third area of buffer 340.

Next, controller 330 searches for a closest sector where received data is to be stored from among the sectors of second track T2 comprising fourth sector S4. Fifth sector S5 is identified as the closest sector. Controller 330 then controls hard disk drive 300 to perform operation S660 to store data of fifth sector S5 in the second area and the third area of buffer 340.

Next, controller 330 identifies third sector S3 as the closest sector and controls hard disk drive 300 to perform operation S670 on third sector S3. Controller 330 then controls hard disk drive 300 to perform operation S670 to write data from the first area and the third area of buffer 340 into third sector S3.

Next, controller 330 identifies fourth sector S4 as the closest sector and controls hard disk drive 300 to perform operation S670 on fourth sector S4. Controller 330 then controls hard disk drive 300 to perform operation S670 to write data from the first area and the third area of buffer 340 into fourth sector S4.

Next, controller 330 identifies fifth sector S5 as the closest sector and controls hard disk drive 300 to perform operation S670 on fifth sector S5. Controller 330 then controls hard disk drive 300 to perform operation S670 to write data from the first area and the third area of buffer 340 into fifth sector S5.

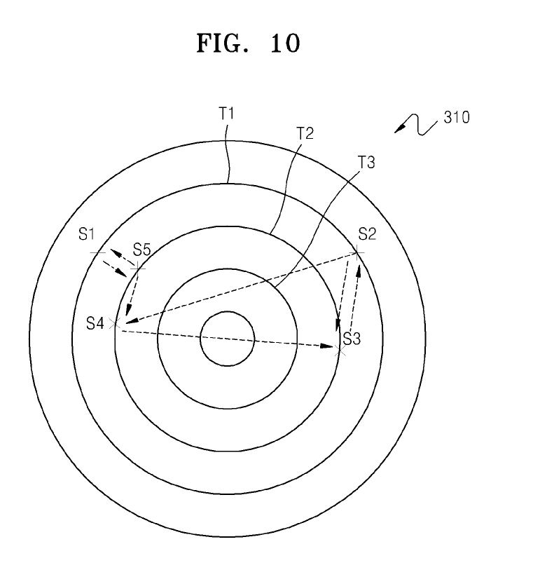

FIG. 10 illustrates yet another example of disk 310 of FIG. 3. FIG. 10 is used to describe an example of the method of FIG. 6. In the example of FIG. 10, data is read and written in a closest sector before data is read or written in other sectors.

Referring to FIGS. 3, 6, and 10, disk 310 comprises first through third tracks T1, T2, and T3 each comprising a plurality of sectors. First track T1 comprises a first sector S1 and a second sector S2, and second track T2 comprises a third sector S3, a fourth sector S4, and a fifth sector S5. First through fifth data is to be written in respective first through fifth sectors S1 through S5. The first through fifth data have different sizes from the respective first through fifth sectors S1 through S5.

Data of first sector S1 is stored in the second area and the third area of buffer 340 by performing operations S620 and S630. Then, controller 330 identifies a sector closest to first sector S1, irrespective of track. Controller 330 identifies fifth sector S5 as the closest sector and then controls hard disk drive 300 to perform operation S660 to store data of fifth sector S5 in the second area and the third area of buffer 340.

Next, controller 330 searches for a sector closest to fifth sector S5, and identifies first sector S1 as the closest sector. Controller 330 then controls hard disk drive 300 to perform operation S670 to write data stored in the first area and the third area of buffer 340 to first sector S1.

Next, controller 330 searches for a sector closest to first sector S1, and identifies fifth sector S5 as the closest sector. Then, controller 330 controls hard disk drive 300 to perform operation S670 to write corresponding data stored in the first area and the third area of buffer 340 into fifth sector S5.

Next, controller 330 searches for a sector closest to fifth sector S5 and identifies fourth sector S4 as the closest sector. Then, controller 330 controls hard disk drive 300 to perform operation S660 to store data from fourth sector S4 into the second area and the third area of buffer 340.

Next, controller 330 searches for a sector closest to fourth sector S4 and identifies third sector S3 as the closest sector. Then, controller 330 controls hard disk drive 300 to perform operation S660 to store data from third sector S3 into the second area and the third area of buffer 340.

Next, controller 330 searches for a sector closest to third sector S3 and identifies second sector S2 as the closest sector. Then, controller 330 controls hard disk drive 300 to perform operation S660 to store data from second sector S2 into the second area and the third area of buffer 340.

Next, controller 330 searches for a sector closest to second sector S2 and identifies third sector S3 as the closest sector. Then, controller 330 controls hard disk drive 300 to perform operation S670 to write corresponding data from the first and third areas of buffer 340 into third sector S3.

Next, controller 330 searches for a sector closest to third sector S3 and identifies second sector S2 as the closest sector. Then, controller 330 controls hard disk drive 300 to perform operation S670 to write corresponding data from the first and third areas of buffer 340 into second sector S2.

Next, controller 330 searches for a sector closest to second sector S2 and identifies fourth sector S4 as the closest sector. Then, controller 330 controls hard disk drive 300 to perform operation S670 to write corresponding data from the first and third areas of buffer 340 into fourth sector S4.

FIG. 11A is a first table 1110 illustrating seek times of head 320 in a write operation. FIG. 11B is a second table 1150 illustrating seek times of head 320 in a read operation. In FIGS. 11A and 11B, a length refers to a distance between cylinders or tracks of hard disk drive 300.

Referring to FIG. 11A, a time taken for head 320 to travel over two tracks to perform a write operation is 1 μs. Referring to FIG. 11B, a time taken for head 320 to travel over two tracks to perform a read operation can be 0.7 μs. Times such as those illustrated in FIGS. 11A and 11B can be used to determine closest sectors in the method of FIG. 6. The times in FIGS. 11A and 11B can be varied in alternative embodiments.

First table 1110 and second table 1150 contain values obtained through experiments. In certain alternative embodiments, first table 1110 uses values obtained through experiments and second table 1150 uses estimated values obtained by using first table 1110. In still other alternative embodiments, second table 1150 uses values obtained through experiments and first table 1110 uses estimated values obtained by using second table 1150.

First table 1110 and second table 1150 can be used to perform operation S640 in the method of FIG. 6. In particular, controller 330 can use first table 1110 or second table 1150 to determine a closest sector. Because seek times of head 320 are different for read and write operations, two tables like first table 1110 and second table 1150 of FIGS. 11A and 11B can be used. Where the seek times of head 320 are the same for read and write operations, a single table can be used.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined by the claims.

What is claimed is:

1. A method of performing a write operation in a disk device comprising a disk having a plurality of sectors, the method comprising:
storing multiple units of data in a first area of a buffer, wherein each of the units of data has a size that is different from a size of a corresponding target sector of the disk;
transferring data to second and third areas of the buffer from a first target sector of the disk, wherein the first target sector corresponds to a first unit of data among the units of data; and
writing the first unit of data from the first area of the buffer to the first target sector and writing the data transferred to the third area of the buffer to the first target sector,
wherein transferring the data to the second and third areas of the buffer comprises storing in the second area of the buffer a part of the data to be replaced by the first unit of data, and storing in the third area of the buffer a remaining part of the data.

2. The method of claim 1, further comprising:
identifying a second target sector as a sector that is closest to the first target sector among target sectors to which the multiple units of data are to be written; and
storing data from the second target sector in the second and third areas of the buffer, or writing one of the units of data from the first area of the buffer to the second target sector.

3. The method of claim 2, wherein storing data from the second target sector in the second and third areas of the buffer is performed upon determining that the data from the second target sector is not currently stored in the second and third area of the buffer, and wherein writing one of the units of data from the first area of the buffer to the second target sector is performed upon determining that the data from the second target sector is currently stored in the second and third area of the buffer.

4. The method of claim 2, wherein identifying the second target sector comprises accessing a table that stores seek times of a disk drive head, and identifying the second target sector as a sector having a lowest seek time relative to the first target sector.

5. The method of claim 4, wherein the table is selected from among a first table storing seek times for write operations, and a second table storing seek times for read operations.

6. The method of claim 5, further comprising selecting the first table upon determining that a write operation is to be performed on the second target sector, and selecting the second table upon determining that a read operation is to be performed on the second target sector.

7. The method of claim 2, wherein identifying the second target sector comprises determining whether a first track containing the first target sector contains any additional target sectors where one of the multiple units of data is to be written, and upon determining that the first track contains at least one additional target sector to which one of the multiple units of data is to be written, identifying one of the at least one additional target sectors as the second target sector.

8. The method of claim 1, wherein the disk device is a hard disk drive.

9. A method of performing a write operation in a disk device, the method comprising:
storing data received from a host in a first area of a buffer;
reading data from a sector to which the received data is to be written;
storing a part of the read data corresponding to the received data in a second area of the buffer;
storing a remaining part of the read data other than the part of the read data corresponding to the received data in a third area of the buffer; and
writing the data stored in the first area and the third area of the buffer to the sector.

10. The method of claim 9, further comprising:
receiving the data from the host;
comparing a size of the received data with a size of the sector to which the received data is to be written; and
reading the data from the sector to which the received data is to be written as a consequence of determining that the size of the received data is different from the size of the sector to which the received data is to be written.

11. The method of claim 9, further comprising:
receiving additional data from the host;
storing the additional data in the first area of the buffer;
comparing a size of the additional data with a size of a second sector to which the additional data is to be written; and
writing the additional data from the first area of the buffer to the second sector.

12. The method of claim 10, wherein the sector has a size of 4 kilobytes.

13. A disk device, comprising:
a disk comprising a plurality of tracks each comprising a plurality of sectors;
a head that writes data to the disk and reads data from the disk;
a buffer comprising a first area, a second area, and a third area; and
a controller that controls the disk device to store data received from a host in the first area, to store data in the second area and the third area from a first target sector to which the received data is to be written, and to write the data stored in the first area and the third area to the first target sector,
wherein the controller controls the disk device to store a part of the read data corresponding to the received data in the second area, and to store a remaining part of the read data other than the part of the read data corresponding to the received data to the third area.

14. The disk device of claim 13, wherein the controller compares a size of the received data with a size of the first target sector;
wherein upon determining that the size of the received data is the same as the size of the first target sector, the controller controls the disk device to store the data in the first area into the first target sector; and
wherein upon determining that the size of the received data is not the same as the size of the first target sector, the controller controls the disk device to transfer data from the first target sector to the second and the third areas, and to write data stored in the first area and the third area into the first target sector.

15. The disk device of claim 13, wherein the controller controls the disk device to store multiple units of data received from the host into the first area, wherein each of the units of data has a size that is different from a size of a corresponding target sector to which the unit of data is to be written.

16. The disk device of claim 15, wherein the controller searches for a second target sector that is closest to the first target sector among target sectors where the multiple units of data are to be written.

17. The disk device of claim 16, wherein the controller controls the disk device to transfer data from the second target sector to the second and third areas or to write data from the first area and the third area to the second target sector.

18. The disk device of claim 16, wherein the controller determines whether data stored in the second target sector has been stored in the second and third areas;
wherein upon determining that the data stored in the second target sector has been stored in the second and third areas, the controller controls the disk device to write data stored in the first and third areas into the second target sector; and
wherein upon determining that the data stored in the second target sector has not been stored in the second and third areas, the controller controls the disk device to transfer data stored in the second target sector into the second and third areas.

19. The disk device of claim 16, further comprising a memory for storing a first table comprising information regarding seek times of the head for write operations and a second table comprising information regarding seek times of the head for read operations,
wherein the controller searches for the second target sector by examining the seek times in the first or second table.

20. The disk device of claim 16, wherein the controller identifies the second target sector by determining whether a first track containing the first target sector contains any additional target sectors in which one of the multiple units of data is to be written, and upon determining that the first track contains at least one additional target sector to which one of the multiple units of data is to be written, identifies one of the at least one additional target sectors as the second target sector.
